(19) United States
(12) Patent Application Publication
(10) Pub. No.: US 2025/0321724 A1
(43) Pub. Date: Oct. 16, 2025

(54) APPARATUS AND METHOD FOR MONITORING OPTIMIZATION PERFORMANCE OF DEEP LEARNING COMPILER

(71) Applicant: Mobilint, Inc., Seoul (KR)

(72) Inventor: Younghoon JUNG, Seoul (KR)

(73) Assignee: Mobilint, Inc., Seoul (KR)

(21) Appl. No.: 19/247,468

(22) Filed: Jun. 24, 2025

Related U.S. Application Data
(63) Continuation of application No. PCT/KR2022/021411, filed on Dec. 27, 2022.

(30) Foreign Application Priority Data
Dec. 27, 2022 (KR) 10-2022-0185878

(51) Int. Cl. G06F 8/41

(52) U.S. Cl. CPC G06F 8/41

(57) ABSTRACT

Disclosed are an apparatus and method for monitoring the optimization performance of a deep learning compiler. The method includes calculating metric information for the evaluation of the performance of a compiler, calculating a score function value corresponding to resource optimization policy information, set in the artificial intelligence (AI)-based optimizer of the compiler, based on the metric information, and providing performance analysis results of the AI-based optimizer based on the score function value.

### CROSS-REFERENCE TO RELATED APPLICATIONS

The present application is a continuation of International Patent Application No. PCT/KR2022/021411 filed on Dec. 27, 2022, which is based upon and claims the benefit of priority to Korean Patent Application No. 10-2022-0185878 filed on Dec. 27, 2022. The disclosures of the above-listed applications are hereby incorporated by reference herein in their entirety.

### BACKGROUND

Embodiments of the inventive concept described herein relate to an apparatus and method for monitoring the optimization performance of a deep learning compiler.

A deep learning compiler performs a resource optimization task to execute a deep learning model on a specific artificial intelligence (AI) accelerator, and generates instructions for the AI accelerator. For example, when the deep learning compiler performs a deep learning workload optimization task for limited hardware resources, it performs scheduling optimization intended to determine the order in which hardware resources will be used to execute a given workload, and generates instructions for execution on actual hardware.

In this case, the optimization task is intended to overcome the combination optimization problem. In this field, desirable performance can be obtained when reinforcement learning is employed.

Meanwhile, the performance of a reinforcement learning-based optimizer applied to a deep learning compiler is determined by training data, just like those of other AI technologies. That is, there are adversarial inputs that produce incorrect results, and desirable performance cannot be guaranteed for unlearned data. Therefore, in order to use reinforcement learning- or AI-based deep learning compiler technology in practice, it is necessary to continuously monitor and manage the performance of a compiler.

### SUMMARY

The inventive concept provides an apparatus and method for monitoring the optimization performance of a deep learning compiler.

The technical objects of the inventive concept are not limited to the above-mentioned ones, and the other unmentioned technical objects will become apparent to those skilled in the art from the following description.

In accordance with an aspect of the inventive concept, there is provided a method of monitoring the optimization performance of a deep learning compiler, the method being performed by an apparatus for monitoring the optimization performance of a deep learning compiler, the method including: calculating metric information for the evaluation of the performance of a compiler; calculating a score function value corresponding to resource optimization policy information, set in the artificial intelligence (AI)-based optimizer of the compiler, based on the metric information; and providing performance analysis results of the AI-based optimizer based on the score function value

In accordance with another aspect of the inventive concept, there is provided an apparatus for monitoring the optimization performance of a deep learning compiler, the apparatus including: a compiler configured to execute resource optimization policies through an artificial intelligence (AI)-based optimizer, and to generate and provide instructions for a deep learning model; a metric module configured to define and calculate metric information for the evaluation of the performance of the compiler; a simulation module configured to calculate a score function value corresponding to resource optimization policy information, set in the optimizer, based on the metric information; and a monitoring module configured to provide performance analysis results of the optimizer based on the score function value

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of an apparatus for monitoring the optimization performance of a deep learning compiler according to one embodiment of the present invention;

FIG. 2 is a flowchart of a method of monitoring the optimization performance of a deep learning compiler according to one embodiment of the present invention;

FIG. 3 is a diagram illustrating detailed steps for providing performance analysis results in one embodiment of the present invention;

FIG. 4 illustrates an algorithm for evaluating current optimization resource policy information by using a score function value; and

FIG. 5 illustrates an algorithm that provides not only redesign information for the resource expansion of hardware but also predicted performance information based on the redesign information.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/of” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

In the present specification, the term “hardware” is used interchangeably with the term “AI accelerator,” and the term “optimizer” is used interchangeably with the term “optimization algorithm” or the term “optimization model.”

Hereinafter, some contents related to the present invention are described to help understanding of those skilled in the art, and then embodiments of the present invention will be described in detail with reference to the accompanying drawings.

In the conventional technology, the performance of a compiler itself is not continuously monitored and managed. That is, since the conventional optimization task of a compiler is performed using heuristic and rule-based optimization policies, the performance of the compiler itself is not a management target. In other words, in the conventional technology, there is no means to monitor the performance of a compiler at all.

However, in deep learning applications, depending on the purpose, it is often necessary to perform compilation so that a given deep learning model achieves best performance in the state of being dependent on specific hardware or to perform compilation so that various types of deep learning models generally achieve high performance on specific hardware. In these two cases, a technology capable of monitoring and evaluating the optimization performance of a compiler is required to develop an optimization algorithm for a compiler or to train an AI-based optimizer that achieves this.

In connection with this, the performance of AI accelerators has been previously evaluated by throughput, which indicates how many inputs (queries) are processed per unit time, but this does not indicate the performance of a compiler itself.

In the compilation of code written in languages such as C and C++, the performance of compilers such as the GNU Compiler Collection (GCC) may be evaluated using the compiler throughput, which indicates the time taken to process the compilation target, the code quality, which indicates the time taken to execute generated instructions, the code size, which indicates the size of the generated instructions, and/or the like. However, the rest of these indicators excluding the code quality are not appropriate for indicating the optimization performance of deep learning compilers.

Furthermore, the conventional technology provides neither information related to the optimization performance of a compiler nor notification information based on this information.

That is, the conventional technology does not provide notification information when an AI-based optimizer exhibits lower optimization performance than usual for a new deep learning model during a compilation process.

Furthermore, when an AI-based optimizer is retrained, optimization performance may decrease even when the same deep learning model is compiled. However, in the conventional technology, there is no means to automatically provide notification information even in a situation where such performance decrease occurs.

Furthermore, in the case of an AI-based optimizer, there is a chance to train a deep learning model, to be distributed, through overfitting to achieve better performance under specific hardware conditions. However, the conventional technology does not provide notification information for such a situation, so that there is no way for a user to become aware of it.

Moreover, when the additional training of an AI-based optimizer yields only a small performance gain, there is no way to identify a bottleneck causing the small performance gain and insufficient resources to be considered for future hardware design.

In order to overcome these various problems, one embodiment of the present invention may set various indicators for effectively monitoring the performance of an AI-based optimizer, may monitor optimization performance, and may provide the performance analysis results of the optimizer as notification information.

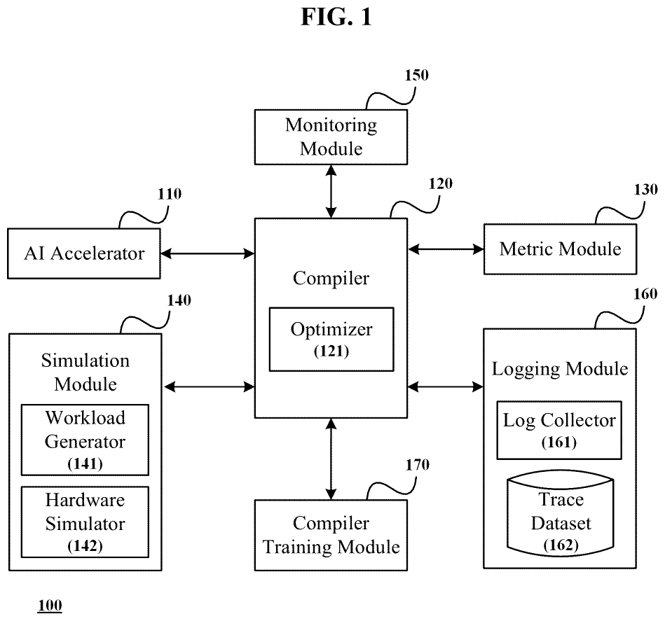

FIG. 1 is a block diagram of an apparatus 100 for monitoring the optimization performance of a deep learning compiler (hereinafter referred to as the “apparatus 100”) according to one embodiment of the present invention.

The apparatus 100 according to the present embodiment includes an AI accelerator 110, a compiler 120, a metric module 130, a simulation module 140, and a monitoring module 150.

The AI accelerator 110 is a hardware accelerator that executes a deep learning model. The AI accelerator 110 executes the instructions output by the compiler 120.

The AI accelerator 110 may include a graphics processing unit (GPU), a neural processing unit (NPU), a field programmable gate array (FPGA), and/or an application-specific integrated circuit (ASIC).

The compiler 120 includes an AI-based optimizer 121, and executes resource optimization policies through the optimizer 121. In this case, the resource optimization policies refer to the rules applied when generating a plan to execute a given workload (a deep learning model to be executed) on given resources (hardware resources). In this case, the plan defines the order in which individual modules of hardware will be executed when executing the deep learning model on the hardware. Since reinforcement learning is applied to the AI-based optimizer 121, the resource optimization policies themselves become a target for training.

Furthermore, the compiler 120 generates instructions for a deep learning model, and provides them to the AI accelerator 110. In this case, one embodiment of the present invention may further include a compiler training module 170 configured to perform the reinforcement learning of the optimizer 121.

The compiler training module 170 performs the reinforcement learning of the AI-based optimizer, and may determine whether to update the existing optimizer 121 in the compiler 120 with a newly trained optimizer or whether to continue to retrain the optimizer having insufficient performance based on the performance evaluation results obtained through simulation.

The metric module 130 defines metric information for the evaluation of the performance of the compiler 120, and calculates metric information corresponding to resource optimization policy information set in the optimizer 121. The metric module 130 calculates the metric information based on the log collected by the logging module 160.

In one embodiment, the metric information includes first to sixth performance indicators, and the calculation of the metric information may be performed by calculating any one of the first to sixth performance indicators or calculating a plurality of indicators.

The first performance indicator (Makespan) is the total time it takes to execute a compiled deep learning model. The first performance indicator indicates that, during the execution of the same deep learning model on given hardware, as the execution time decreases, the performance becomes better.

The second performance indicator (DMA blocking ratio) represents the ratio of the computational blocking time attributable to DMA in the total makespan. The second performance indicator indicates that, during the execution of the same deep learning model on given hardware, as the ratio value decreases, the performance becomes better.

DMA Blocking Ratio=(DMA Blocking Time)/Makespan (1)

The third performance indicator (PE-array packing ratio) represents the ratio of the time for which the processing element array (PE-array) is utilized in the total makespan. The third performance indicator indicates that, during the execution of the same deep learning model on given hardware, as the ratio value increases, the performance becomes better.

PE-Array Packing Ratio=(PE-Array Active Time)/Makespan (2)

The fourth performance indicator (DMA-convolution ratio) represents the number of direct memory accesses (DMAs) per convolution operation of the deep learning model by a ratio. The fourth performance indicator indicates that, during the execution of the same deep learning model on given hardware, as the ratio value decreases, the performance becomes better.

The fifth performance indicator (critical path length) represents the length of the graph generated as a result of optimization under the same hardware conditions. As the length of the graph generated by optimization decreases, fewer hardware components are passed through, and thus the performance becomes better.

In this case, the graph generated as a result of optimization means that, given hardware and a plan to sequentially execute individual modules of the hardware, the order in which individual modules of the hardware are executed is represented by a directed graph with the dependencies between the individual modules taken into consideration. In this case, the vertices of a graph structure correspond to respective hardware modules, and directed edges refer to the execution order of the hardware with the dependencies taken into consideration. The edges of the graph may have weights (e.g., the operating times of the modules). As a result, the shortest one of the lengths of the paths calculated by taking into consideration weights for the paths connecting the root node of the graph to the terminal nodes is defined as the fifth performance indicator “critical path length.”

The sixth performance indicator (buffer packing ratio) represents buffer usage efficiency during the total compilation execution time. During the execution of the same deep learning model on given hardware, as the ratio value increases, the performance becomes better.

The simulation module 140 simulates the deep learning model execution of the given hardware for the evaluation of the performance of the compiler 120. The simulation module 140 includes a workload generator 141 configured to generate a workload set for the evaluation of the performance of the compiler 120 and a hardware simulator 142 configured to provides simulation based on hardware specification information (e.g., memory, a buffer, DMA, and/or the like). In this case, the workload set refers to a deep learning model set for simulation. The logging module 160 includes a log collector 161 configured to collect a log, and stores a trace dataset 162. In this case, the log collector 161 may collect a log generated by the deep learning model execution of the hardware, i.e., the AI accelerator 110, or the simulation of the simulation module 140. The trace dataset 160 may include hardware specification information, workload set information, resource optimization policy information, metric information, and/or the like used in the AI accelerator 110 or simulation. The trace dataset 162 may be used in a process for the reinforcement learning of the optimizer 121 performed by the compiler training module 170.

The monitoring module 150 monitors the performance of the optimization model of the compiler 120 based on the log collected by the logging module 160 and the metric information calculated by the metric module 130. To this end, the monitoring module 150 calculates a score function value corresponding to the resource optimization policy information, set in the optimizer 121, based on the metric information. In this case, the score function value is intended to score the performance of the optimizer, i.e., to evaluate whether the resource optimization policy information is appropriate for the given hardware and workload. By taking into consideration the practical aspect, a reward function used in reinforcement learning may be utilized.

Furthermore, the monitoring module 150 may monitor the performance of the optimizer 121 by collecting the log of the AI accelerator 110 that executes a specific deep learning model after actual compilation, not simulation.

The monitoring module 150 provides the performance analysis results of the optimizer 121 based on the score function value. The monitoring module 150 may include rules for monitoring, rules for the provision of notification information, and components for monitoring.

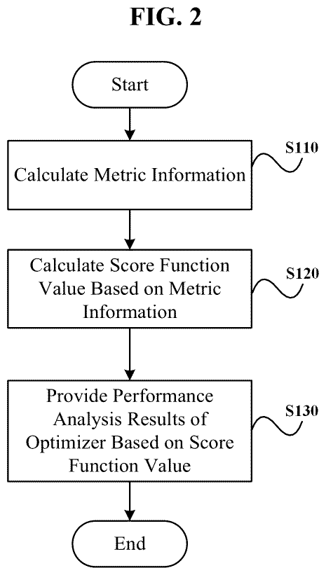

A method performed by the apparatus 100 for monitoring the optimization performance of a deep learning compiler according to one embodiment of the present invention will be described below with reference to FIGS. 2 to 5.

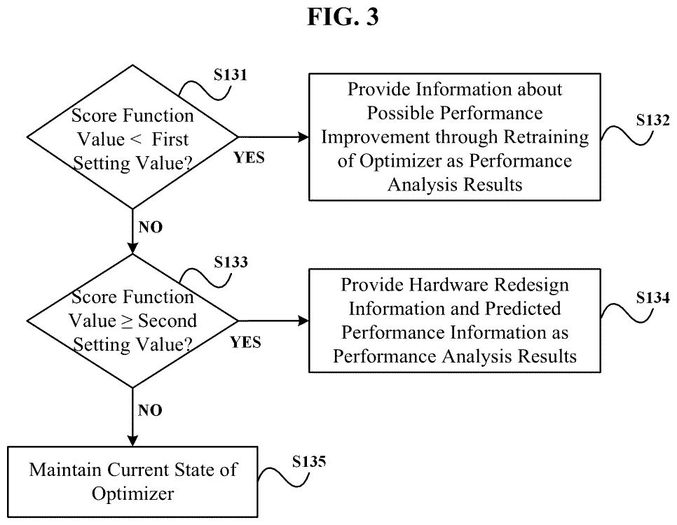

FIG. 2 is a flowchart of a method of monitoring the optimization performance of a deep learning compiler according to one embodiment of the present invention. FIG. 3 is a diagram illustrating detailed steps for providing performance analysis results in one embodiment of the present invention.

First, the metric module 130 calculates metric information for the evaluation of the performance of the compiler 120 in step S110. As described above, the metric information targets the first to sixth performance indicators, and may be provided in the form in which one or more of them are present individually or in combination.

Next, the monitoring module 150 calculates a score function value corresponding to resource optimization information, set in the optimizer 121 of the compiler 120, based on the metric information in step S120.

The score function refers to a function for the scoring of the performance of the optimizer 120. The score function is intended to evaluate the performance that the resource optimization policy information determined by the optimizer 121 exhibits for given hardware and workload, and uses hardware specification information, a deep learning workload, and resource optimization policy information as inputs.

Thereafter, the monitoring module 150 provides the performance analysis results of the optimizer 121 based on the score function value in step S130.

In one embodiment, the monitoring module 150 may compare the calculated score function value with a preset first setting value in step S131, and may provide information about possible performance improvement through the retraining of the optimizer 121 as the performance analysis results when it is determined as a result of the comparison that the calculated score function value is smaller than the first setting value in step S132.

That is, when the score function value calculated in accordance with the resource optimization policy information currently set in the optimizer 121 for a workload set prepared for a specific deep learning model is smaller than the first setting value, there is a possibility that the monitoring module 150 may improve performance by performing the retraining of the optimizer 121 for a specific deep learning model operating under specific hardware conditions, and thus the optimizer 121 may provide information about this possibility to a user as the analysis results.

In contrast, the simulation module 140 may compare the calculated score function value with a preset second setting value in step S133, and may provide redesign information for the resource expansion of hardware and predicted performance information based on the redesign information as the performance analysis results when it is determined as a result of the comparison that the calculated score function value is equal to or larger than the second setting value in step S134.

That is, when the score function value calculated in accordance with the resource optimization policy information currently set in the optimizer 121 for a workload set prepared for various deep learning models is equal to or larger than the second setting value, it is difficult to expect the general performance improvement of the optimizer 121 through additional learning. In this case, the monitoring module 150 may provide a user with the opinion that resources need to be increased through hardware-level redesign as the performance analysis results. In this case, the monitoring module 150 may predict the extent of performance improvement that can be expected for the increased resources and inform the user of the predicted extent.

Meanwhile, the second set value may be a value larger than the first setting value by a predetermined value or more. In this case, the simulation module 140 may maintain the current state of the optimizer 121 without change when the score function value falls between the first setting value and the second setting value in step S135.

Meanwhile, in the process of providing performance analysis results based on a score function value, it is necessary to identify a maximum score function value for the identification of the best performance that can be obtained through learning (training). To this end, one embodiment of the present invention may use the workload generator 141 and reinforcement learning.

For example, when the hardware specification information is h, the workload data information is d, and the resource optimization policy information is π, the score function value L may be represented by Equation 3 below:

L=L(h,d,π) (3)

In addition, it is assumed that a set R of criteria set from the first to sixth performance indicators, which is the metric information, are given. In this case, the set R of criteria may include a condition in which each of the first to sixth performance indicators is larger than or smaller than a specific threshold value.

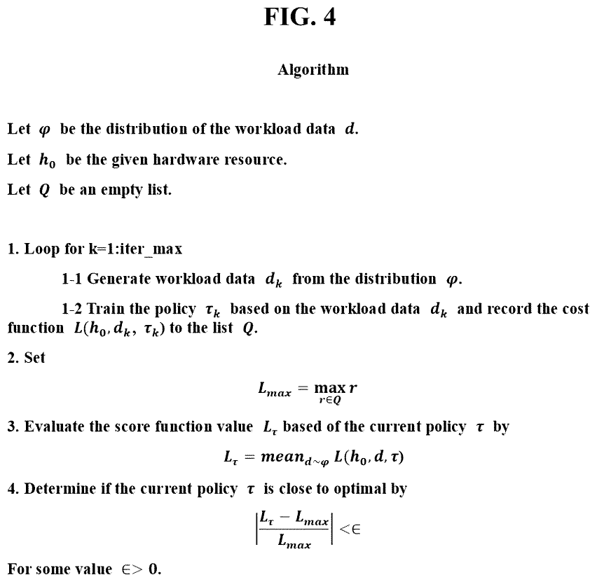

Referring to the algorithm shown in FIG. 4, the score function values obtained during training are recorded while the optimizer is being trained through reinforcement learning using current hardware specification and workload data, and then the largest one of the recorded score function values is set as the maximum score function value that can be obtained with current hardware specifications. Furthermore, the score function value is calculated for current optimization resource policy information, and then it is checked how close this value is to the maximum score function value. When it is determined as a result of the checking that the current score function value has reached the maximum score function value, the training may be stopped. A model that has recorded the largest one of the score function values obtained during training while the optimizer is being trained through reinforcement learning may be applied when updating the optimizer.

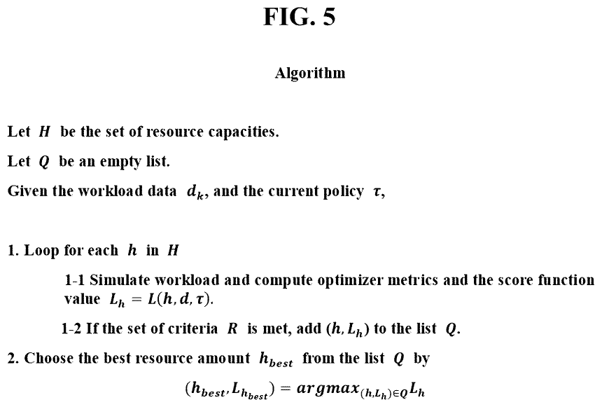

In addition, FIG. 5 shows an algorithm that provides not only the redesign information for the resource expansion of hardware but also the predicted performance information based on the redesign information, which have been described above.

More specifically, the algorithm of FIG. 5 may fix workload data and resource optimization policy information to given values, may perform simulation while changing hardware resources, may determine an optimal hardware resource value by calculating and comparing metrics, and may propose the determined hardware resource value as redesign information.

For example, the magnitude of an appropriate buffer size may be predicted through the algorithm of FIG. 5. As another example, redesign information may be provided to add a PE-array to hardware or to expand the bandwidth of DRAM.

In one embodiment of the present invention, the monitoring module 150 may also evaluate the performance when the AI accelerator 110 directly executes the instructions of compilation results. In this case, the measured log and metric information may be different from those of simulation. Furthermore, the collected log and metric information may be utilized for the purpose of securing a trace dataset in a process for the reinforcement learning of the optimizer.

One embodiment of the present invention may evaluate the optimization performance of the compiler 120, and may monitor the performance of the compiler 120 and provide the results of the monitoring as notification information simultaneously or separately.

The monitoring module 150 may provide notification information when monitoring results for the performance of the compiler 120 satisfy a predetermined notification rule. That is, the monitoring module 150 may output the monitoring results directly to a dashboard, or may output the monitoring results to the dashboard when a predetermined performance change is detected.

Meanwhile, in the above description, steps S110 to S130 may be further divided into additional steps or combined into fewer steps, depending on the implementation of the present invention. Furthermore, some steps may be omitted as needed, and the order of the steps may be changed.

In some embodiments, the above-discussed method of FIGS. 2 to 3, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIGS. 2 to 3 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, whether to update the existing optimizer in the compiler with a newly trained optimizer or to continue to retrain the trained optimizer may be determined by evaluating the overall performance before applying the AI-based optimizer to the compiler through simulation.

In addition, by evaluating the current performance of the optimizer using simulation, and providing notification information when a problem such as a bottleneck occurs and, at the same time, providing a user with a hardware redesign plan to overcome the problem and information about possible performance improvement expected upon redesign, it may be possible to improve the performance of the AI accelerator by overcoming the bottleneck of hardware itself even in a situation where the reinforcement learning of the AI-based optimizer is limited.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A method of monitoring optimization performance of a deep learning compiler, the method being performed by an apparatus for monitoring optimization performance of a deep learning compiler, the method comprising:
calculating metric information for evaluation of performance of a compiler;
calculating a score function value corresponding to resource optimization policy information, set in an artificial intelligence (AI)-based optimizer of the compiler, based on the metric information; and
providing performance analysis results of the AI-based optimizer based on the score function value.

2. The method of claim 1, wherein calculating the metric information comprises:
generating hardware specification information and workload set information for evaluation of performance of the compiler;
executing a simulation based on the hardware specification information and the workload set information;
collecting a log corresponding to the simulation; and
calculating metric information for evaluation of performance of the compiler based on the log.

3. The method of claim 1, wherein calculating the metric information comprises:
calculating metric information, including one or more of a first performance indicator indicating a total time taken for a compiled deep learning model to be executed, a second performance indicator indicating an operation blocking time attributable to direct memory access (DMA) during the total time, a third performance indicator indicating a time for which a processing element array is utilized during the total time, a fourth performance indicator indicating a number of direct memory accesses (DMAs) per convolution operation, a fifth performance indicator indicating a length of a graph generated as a result of optimization under same hardware conditions, and a sixth performance indicator indicating buffer usage efficiency during an overall compilation execution time.

4. The method of claim 1, wherein calculating the score function value comprises:
calculating the score function value by utilizing a score function that uses hardware specification information, a deep learning workload, and the resource optimization policy information as inputs.

5. The method of claim 4, wherein providing the performance analysis results comprises:
comparing the calculated score function value with a preset first setting value; and
when it is determined as a result of the comparison that the calculated score function value is smaller than the first setting value, providing information about possible performance improvement through reinforcement learning-based retraining of the AI-based optimizer as the performance analysis results.

6. The method of claim 5, wherein providing the information about performance improvement comprises:
providing information about performance improvement of the AI-based optimizer for a specific deep learning model operating under specific hardware conditions as the performance analysis results.

7. The method of claim 4, wherein providing the performance analysis results comprises:
comparing the calculated score function value with a preset second setting value; and
when it is determined as a result of the comparison that the calculated score function value is equal to or larger than the second setting value, providing redesign information for resource expansion of hardware and predicted performance information based on the redesign information as the performance analysis results.

8. The method of claim 7, wherein providing the redesign information and the predicted performance information comprises:
providing redesign information for resource expansion of hardware in which a plurality of various deep learning models can universally operate and predicted performance information as the performance analysis results.

9. The method of claim 1, further comprising providing notification information when a monitoring result for performance of the AI-based compiler satisfies a predetermined notification rule.

10. An apparatus for monitoring optimization performance of a deep learning compiler, the apparatus comprising:
a compiler configured to execute resource optimization policies through an artificial intelligence (AI)-based optimizer, and to generate and provide instructions for a deep learning model;
a metric module configured to define and calculate metric information for evaluation of performance of the compiler;
a simulation module configured to calculate a score function value corresponding to resource optimization policy information, set in the optimizer, based on the metric information; and
a monitoring module configured to provide performance analysis results of the optimizer based on the score function value.
